(19) United States
(12) Patent Application Publication
(10) Pub. No.: US 2004/0164961 A1
(43) Pub. Date: Aug. 26, 2004

(54) Method, system and computer product for continuously monitoring data sources for an event of interest

(76) Inventors: Debasis Bal, Bangalore (IN); Gopi Subramanian, Bangalore (IN); Srikanth Rajagopalan, Bangalore (IN); Abhinanda Sarkar, Bangalore (IN)

Correspondence Address: General Electric Company, CRD Patent Docket Rm 4A59, Bldg. K-1, P.O. Box 8, Schenectady, NY, 12301, US

(21) Appl. No.: 10/371,724

(22) Filed: Feb. 21, 2003

(51) Int. Cl. G09G 5/08

(52) U.S. Cl. 345/163

(57) ABSTRACT

Method, system and computer product for continuously monitoring data sources for an event of interest. A continuous stream of data from the plurality of data sources is received and the data that relates to the event of interest is extracted and stored in a historical database. Analytics is performed on the stored data that relates to the event of interest. In addition, the stored data is monitored according to the performed analytics to find data that relates to the event of interest.

### BACKGROUND OF THE INVENTION

This disclosure relates generally to computing and monitoring an event of interest continuously from a set of data sources and more specifically, to monitoring the financial health of a corporation, firm or other entity to predict it's potential to default.

Financial analysts typically monitor the financial health of a corporation by analyzing many of the publicly available sources of financial information. Financial data sources like CNN Money and Yahoo Finance, for example, provide information regarding the financial assets of corporations in the form of capital market transactions. Capital market transactions may include information such as primary and secondary transactions, initial public offerings (IPOs), privatizations, equity related instruments, pre-IPO financing, pre-IPO transactions and share buy-backs. Typically, analysts analyze the transaction data resulting from such trading to determine the financial health of the corporation.

A challenge with using these types of data sources is the effective collection, processing and analysis of the continuous flow of information related to the transaction data. Also, the continuous stream of data may originate from heterogeneous data sources and hence there is a challenge in effectively collecting and processing this continuous stream of information.

Therefore, there is a need for an automated data management model that can collect, process and analyze a continuous stream of data from a plurality of heterogeneous data sources to monitor an event of interest.

### BRIEF DESCRIPTION OF THE INVENTION

In one embodiment, a method and a computer readable medium to continuously monitor a plurality of data sources for an event of interest is provided. A continuous stream of data from the plurality of data sources is received and the data that relates to the event of interest is extracted and stored in a historical database. Further, analytics is performed on the stored data that relates to the event of interest. In addition, the stored data is monitored according to the performed analytics to find data that relates to the event of interest.

In a second embodiment, there is an Internet-based method and a computer readable medium to continuously monitor a plurality of data sources for information that relates to an event of interest. In this embodiment, an agent is configured to search and download a plurality of web pages containing information related to the plurality of data sources at pre-determined intervals according to specific search criteria. The data in the web pages is parsed and stored in a data repository. Further, the data is extracted from the data repository to determine the parameters of interest related to the event of interest. In addition, the determined parameters of interest are continuously monitored to find information that relates to the specific event.

In a third embodiment, there is a system to continuously monitor a plurality of data sources for an event of interest. The system comprises an agent configured to automatically search and download data from the plurality of data sources at pre-determined time intervals; a data extraction component configured to extract data that relates to the event of interest from the data downloaded by the agent; a database configured to store the extracted data that relates to the event of interest; and an analytics engine configured to perform analytics on the stored data.

In a fourth embodiment, there is a method in a computer system to display a plurality of pages to enable a user to view information related to quoted financial assets of an entity to determine the financial health of the entity. The method comprises displaying an input screen for permitting the user to input a request to search for the entity, displaying a query screen for permitting a user to query data related to the financial assets for the searched entity, and displaying an alert screen for permitting the user to view a recent change to the financial health of at least one entity.

In a fifth embodiment, there is a system to continuously monitor a plurality of data sources for an event of interest. The system comprises a processing unit that further comprises a data fetch entity configured to automatically search and download the continuous stream of data from a plurality of data sources; a data extraction entity configured to extract data that relates to the event of interest from the continuous stream of data; and an analytics engine configured to compute and monitor a parameter of interest related to the event of interest from the extracted data. In addition, the system comprises a memory unit configured to store a plurality of data used by the processing unit and a user interface configured to interface the processing unit with a user.

### BRIEF DESCRIPTION OF THE DRAWINGS

FIG. 1 shows a schematic of a general-purpose computer system in which a data download and analytics engine subsystem for monitoring an event of interest operates;

FIG. 2 shows a top-level component architecture diagram of the data download and analytics engine subsystem that operates on the computer system shown in FIG. 1;

FIG. 3 is a detailed view of a data fetch entity within the data download and analytics engine subsystem;

FIG. 4 is a detailed view of a data extraction, transformation and loading entity within the data download and analytics engine subsystem;

FIG. 5 is a detailed view of an analytics engine within the data download and analytics engine subsystem;

FIG. 6 is a flowchart describing the process of the data download and analytics engine subsystem;

FIG. 7 is a flowchart describing in further detail the “data download” step of FIG. 6;

FIG. 8 is a flowchart describing in further detail the “extract data, transform and load to historical data repository” step of FIG. 6;

FIG. 9 is a flowchart describing in further detail the “run analytics” step of FIG. 6; and

FIGS. 10a-10e show various screen displays that may be presented to a user of the data download and analytics engine subsystem.

### DETAILED DESCRIPTION OF THE INVENTION

In this disclosure, there is a description of a method, system and computer product for monitoring the financial health of a corporation, firm or other entity to predict an event of interest, such as the potential of the corporation, firm or other entity to default. In this disclosure, the event of interest can include financial assets, corporate leasing decisions, weather forecasts, medical systems and chemical systems, however, one of skill in the art will recognize that the teachings of this disclosure are suitable for other types of events. The monitoring involves performing analytics on transaction data corresponding to the financial assets of the corporation to determine its potential to default. The transaction data may originate from a set of heterogeneous data sources, which can include but are not limited to, the Internet, local intranets, share drives, databases and subscription services. This disclosure provides a data download and analytics engine subsystem that performs the functions of an automated data management model, which collects, processes and analyzes this continuous stream of transaction data to enable analysts and investors to monitor an event of interest such as a corporate default and also predict patterns of default behavior exhibited by corporations with greater accuracy.

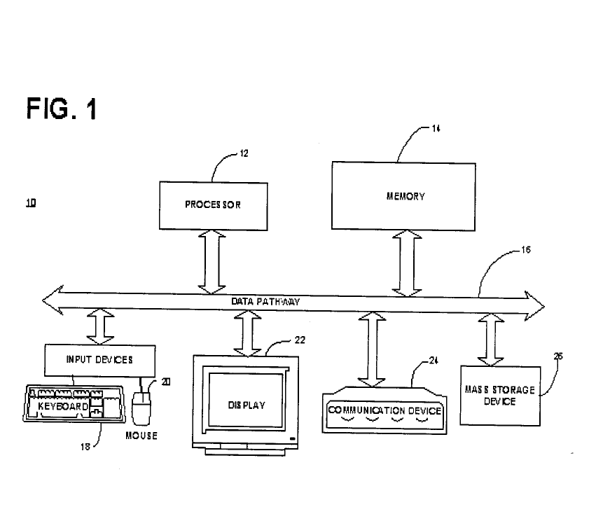

FIG. 1 shows a schematic of a general-purpose computer system 10 in which a data download and analytics engine subsystem for monitoring the financial health of corporations operates. The computer system 10 generally comprises at least one processor 12, a memory 14, input/output devices, and data pathways (e.g., buses) 16 connecting the processor, memory and input/output devices.

The computer system 10 may be in communication with a plurality of transaction systems pertaining to the financial assets of corporations, using any suitable arrangement and any suitable devices such as the Internet; however, any suitable network might be used. Further, it is not necessary that the transaction data from the transaction systems be obtained from a network. For example, the transaction data might be provided on weekly compact discs (CDs) that are mailed.

The processor 12 accepts instructions and data from the memory 14 and performs various data processing functions of the data download and analytics engine subsystem like data fetching, data extraction, transformation and loading and data analysis. The processor 12 includes an arithmetic logic unit (ALU) that performs arithmetic and logical operations and a control unit that extracts instructions from memory 14 and decodes and executes them, calling on the ALU when necessary.

The memory 14 stores a variety of data computed by the various data processing functions of the data download and analytics subsystem. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices. The information in the memory 14 might be conveyed to a human user through the input/output devices, and data pathways (e.g., buses) 16, in some other suitable manner.

The input/output devices may comprise a keyboard 18 and a mouse 20 that enter data and instructions into the computer system 10. Also, a display 22 may be used to allow a user to see what the computer has accomplished. Other output devices may include a printer, plotter, synthesizer and speakers. A communication device 24 such as a telephone or cable modem or a network card such as an Ethernet adapter, local area network (LAN) adapter, integrated services digital network (ISDN) adapter, or Digital Subscriber Line (DSL) adapter, enables the computer system 10 to access other computers and resources on a network such as a LAN or a wide area network (WAN). A mass storage device 26 may be used to allow the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media.

The above-described computer system 10 can take the form of a hand-held digital computer, personal digital assistant computer, notebook computer, personal computer, workstation, mini-computer, mainframe computer or supercomputer.

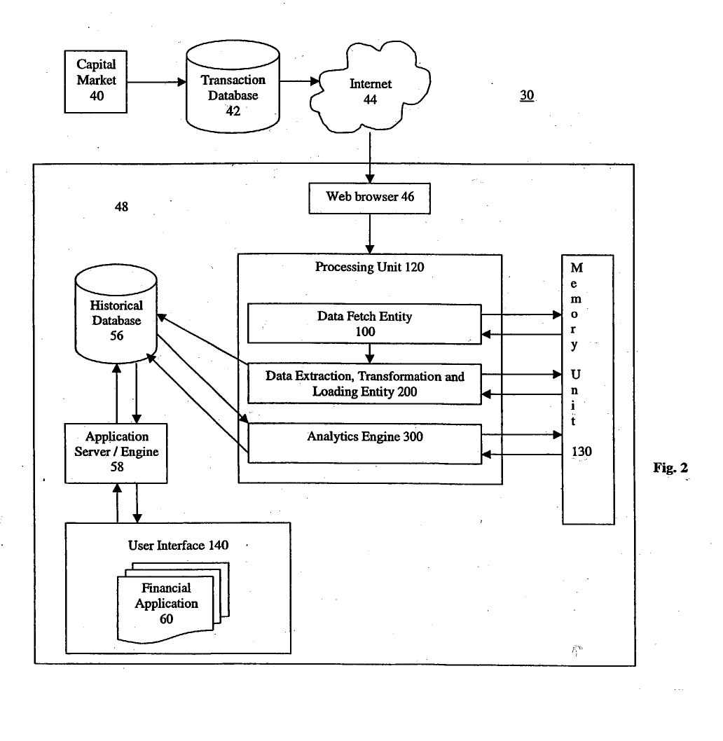

FIG. 2 shows a top-level component architecture diagram of a financial data monitoring system 30 comprising a data download and analytics engine subsystem 48 that operates on the computer system 10 of FIG. 1. The monitoring system 30 generally comprises the capital markets 40, a transaction database 42, a web browser 46 and a data download and analytics engine subsystem 48.

The data download and analytics engine subsystem 48 comprises a processing unit 120, a memory unit 130, a user interface 140, a historical database 56 and an application server/engine 58. The processing unit 120 performs the data processing of the computer system 10. The memory unit 130 stores a variety of data used by the processing unit 120. The user interface 140 allows the computer system 10 to interface with a human user and/or another operating system. For example, the user interface 140 might be in the form of a keyboard, mouse and monitor. The user interface 140 further comprises a financial application 60 that displays the results of the analytics of the data download and analytics engine subsystem 48. Financial data sources like CNN Money and Yahoo Finance, stream information regarding financial assets of corporations in the form of capital market transactions. The transaction database 42 stores the transaction data from the capital markets. Capital market transactions usually include information such as primary and secondary transactions, initial public offerings (IPOs), privatizations, equity related instruments, pre-IPO financing, pre-IPO transactions and share buy-backs. The transaction database 42 then streams the stored capital market transaction data to the Internet 44 by means of bond quotes, for example. The Internet 44 represents a perpetual data source to download the transaction data from the transaction database 42. The web browser 46 searches the Internet 44 to download the capital market transaction data. The downloaded data is then passed to the data download and analytics engine subsystem 48.

The processing unit 120 of the data download and analytics engine subsystem 48 comprises a data fetch entity 100, a data extraction, transformation and loading entity 200 and an analytics engine 300. The data download and analytics engine subsystem 48 activates the web browser 46 at predefined intervals of time, which in turn loads the transaction data from the transaction database 42 through the Internet 44. Once the relevant data is loaded by the data fetch entity 100, the data extraction, transformation and loading entity 200 gets activated and parses the data to perform required validations and transformations to clean the data from unwanted elements. After the data is cleaned, it is loaded onto the historical database 56 in appropriate tables.

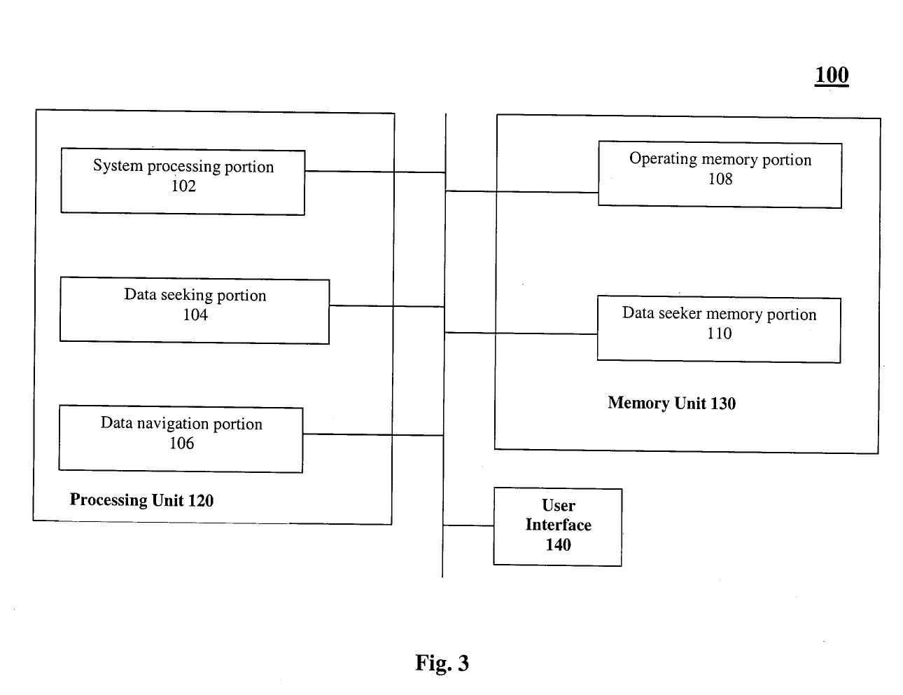

The historical database 56 is a collection of data items organized as a set of pre-defined tables from which data can be accessed or reassembled in many different ways. The historical database 56 represents a permanent memory store and is used to store the computations performed by the data extraction, transformation and loading entity 200 and the analytics engine 300 according to the structure defined in the set of tables. The analytics engine 300 then extracts the relevant data that relates to an event of interest, for example, the default frequency exhibited by a corporation, from the historical database 56. Then the analytics engine 300 computes a parameter that relates to the event of interest. The computed parameter values are loaded back into the historical database 56 by the analytics engine 300. The historical database 56 passes the computed parameter values to the application server/engine 58. The application server/engine 58 then displays the computed parameters on the application 60 in the form of a web page. The information on the web page may indicate transitions in the default frequency of the corporation over a time window numerically and graphically. The data download and analytics engine subsystem 48 is described below in further detail with reference to FIGS. 3-5.

FIG. 3 is a block diagram illustrative of the data fetch entity 100 within the data download and analytics engine subsystem 48. As shown, the processing unit 120 of the data fetch entity 100 includes a system processing portion 102. The system processing portion 102 handles a variety of operations in the processing unit 120, including general operations. These general operations might include controlling the input and output of data, control of overall processing and routine error recovery operations. The processing unit 120 also includes a data seeking portion 104 and a data navigation portion 106. The data seeking portion 104 activates a data fetching agent to automatically search and download web pages containing online transaction data related to capital market transactions at pre-determined time intervals. The data navigation portion 106 simulates navigation clicks between successive web pages containing the transaction data. The various components of the processing unit 120 may be in communication with each other through a suitable interface.

The memory unit 130 of the data fetch entity 100 includes an operating memory portion 108. The operating memory portion 108 contains a variety of data used in the general operations of the data fetch entity 100. The memory unit 130 also contains a data seeker memory portion 110. The data seeker memory portion 110 stores the set of web pages downloaded by the data fetching agent. The data seeker memory portion 110 gets refreshed with page navigation when the data fetching agent downloads a fresh set of web pages. The information in the data seeker memory portion 110 might be conveyed to a human user through the user interface 140, or in some other suitable manner.

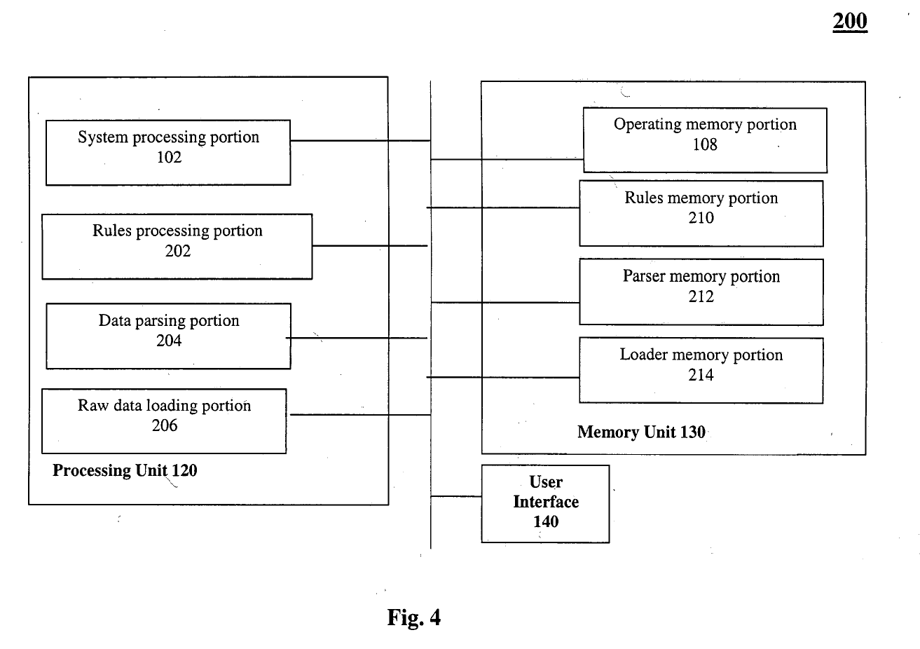

FIG. 4 is a block diagram illustrative of the data extraction, transformation and loading entity 200 within the data download and analytics engine subsystem 48. As shown, the processing unit 120 of the data extraction, transformation and loading entity 200 includes a system processing portion 102. The system processing portion 102 handles a variety of operations in the processing unit 120 including general operations. These general operations might include controlling the input and output of data, control of overall processing and routine error recovery operations. The processing unit 120 also includes a rules processing portion 202, a data parsing portion 204 and a raw data loading portion 206. The rules processing portion 202 handles the various rules for extracting data from the set of web pages downloaded by the data fetch entity 100 based on the structure of the elements that form the web page. Rules may include rules for removing extraneous characters from the data in the web pages and rules for converting the data in the web pages into a format appropriate for parsing. For example, a format conversion rule could include converting all numerical data appearing in text format in the web pages into a numeric format. The data parsing portion 204 extracts data related to the event of interest by validating and transforming the data in the web pages based on the above rules. Validating and transforming the data involves making “sanity checks” on the allowable ranges to the values of the extracted data after the application of the above rules. This is done to make sure that that meaningful data is extracted from the web pages. The raw data loading portion 206 connects to the historical database 56 loads the extracted data onto the database. The various components of the processing unit 120 may be in communication with each other via a suitable interface.

The memory unit 130 of the data extraction, transformation and loading entity 200 includes an operating memory portion 108. The operating memory portion 108 contains a variety of data used in the general operations of the data extraction, transformation and loading entity 200. The memory unit 130 also contains a rules memory portion 210, a parser memory portion 212 and a loader memory portion 214. The rules memory portion 210 contains data to load, interpret and implement the rules for data extraction from the set of web pages. The parser memory portion 212 is assigned for storage of the validated and transformed data extracted from the set of web pages. The loader memory portion 214 stores information related to database connection parameters and formation of queries. The information in the loader memory portion 214 might be conveyed to a human user through the user interface 140, or in some other suitable manner.

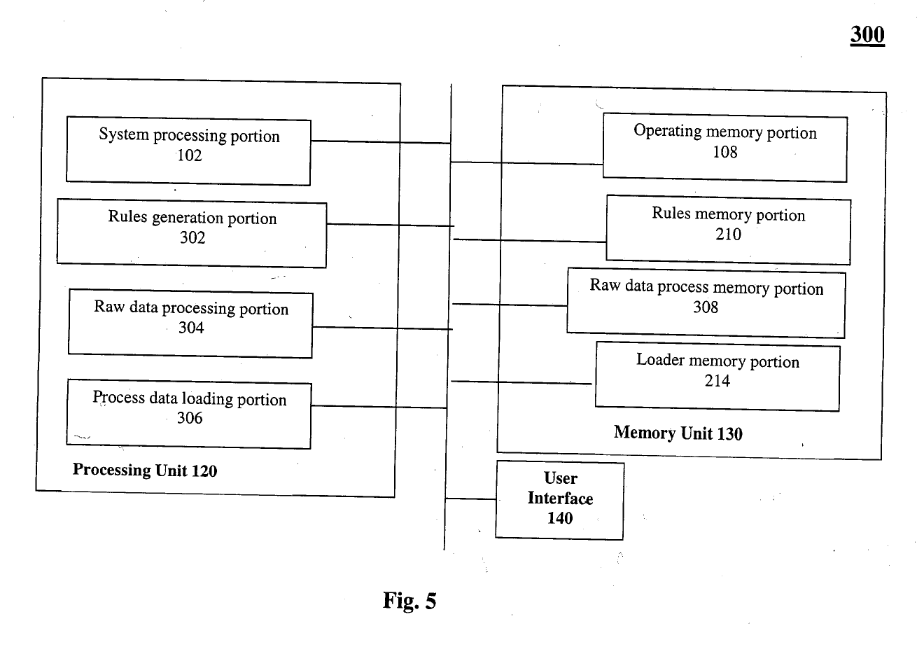

FIG. 5 is a block diagram illustrative of an analytics engine 300 within the data download and analytics engine subsystem 48. As shown, the processing unit 120 of the analytics engine 300 includes a system processing portion 102. The system processing portion 102 handles a variety of operations in the processing unit 120, including general operations. These general operations might include controlling the input and output of data, control of overall processing and routine error recovery operations. The processing unit 120 further includes a rules generation portion 302, a raw data processing portion 304 and a process data loading portion 306. The rules generation portion 302 contains rules for parameter classification into pre-defined threshold ranges that reflect the financial stability of the corporation. These ranges are indicative of the probability or tendency of a corporation to default at a point in time. The ranges classify corporations into high-risk corporations, moderate risk corporations and low-risk corporations.

The raw data processing portion 304 computes the parameters that relate to the event of interest from the data extracted by the data extraction, transformation and loading entity 200. The process data loading portion 306 loads the computed parameter onto the historical database 56. The various components of the processing unit 120 may be in communication with each other via a suitable interface.

The memory unit 130 of the analytics engine 300 includes an operating memory portion 108. The operating memory portion 108 contains a variety of data used in the general operations of the analytic engine 300. The memory unit 130 also contains a rules memory portion 210, a raw data process memory portion 308 and a loader memory portion 214. The rules memory portion 210 stores the rules for parameter classification and comparison based on pre-defined threshold ranges. The raw data process memory portion 308 stores the calculated parameter values. The loader memory portion 214 stores the database connection parameters and formation of queries. The information in the loader memory portion 214 might be conveyed to a human user through the user interface 140, or in some other suitable manner.

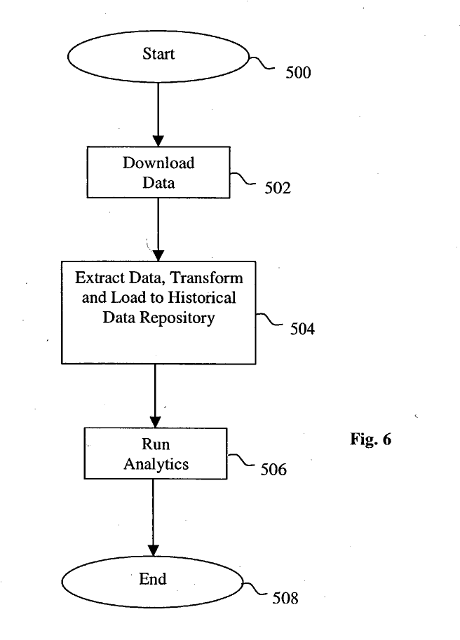

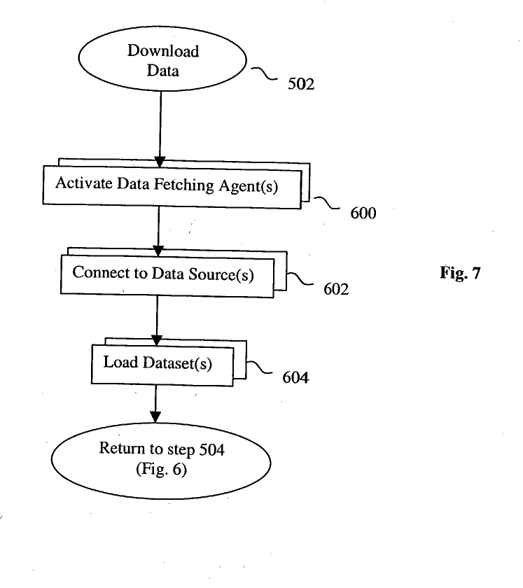

The manner in which the data fetch entity 100, the data extraction, transformation and loading entity 200 and the analytics engine 300 operate is described in further detail with reference to FIG. 6, 7, 8 and 9 respectively.

FIG. 6 is a high level flowchart describing the complete process of the data download and analytics engine 48. As shown, the process of FIG. 6 starts in step 500 and then passes to step 502. In step 502, the transaction data is downloaded. This step involves activating a data fetching agent to search for and download a set of web pages containing transaction data. In step 504, data from the downloaded web pages that relate to the event of interest is extracted, transformed and loaded into the historical database 56. In step 506, analytics is run on the stored data in the historical database 56 to compute a parameter that relates to the event of interest. In step 508, the process ends. Further details of steps 502-506 are described below in more detail.

FIG. 7 is a flowchart showing in further detail the “download data” step 502 of FIG. 6. After the sub-process of FIG. 7 starts in step 502, the sub-process passes to step 600. In step 600, the data fetching agent is activated. The data fetching agent consists of a web browser object with target URL information and appropriate search criteria embedded in it. The data fetching agent is activated at pre-defined intervals of time to download the set of web pages containing transaction data. One of ordinary skill in the art will recognize that more than one agent can be used to download data if desired. In step 602, the web browser object connects to the data sources containing the transaction data specified in the target URL. In step 604, appropriate search criteria are applied to load a set of datasets containing the transaction data from the web pages. Then, the sub-process passes to step 504 in FIG. 6.

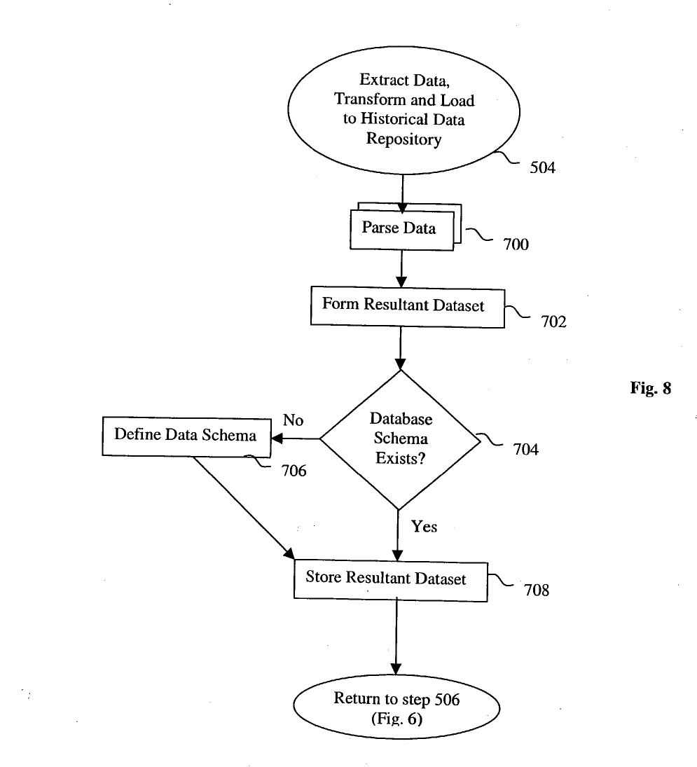

FIG. 8 is a flowchart showing in further detail the “extract data, transform and load to historical database” step 504 of FIG. 6. After the sub-process of FIG. 8 starts in step 504, the sub-process passes to step 700. In step 700, the data from the datasets is parsed for desired validations and transformations to extract data that is relevant to the event of interest. In step 702, the parsed datasets are stored in temporary memory locations. In step 704, a check is made to determine the existence of a database schema to store the parsed data sets. If the condition in step 704 is not true, the sub-process of FIG. 8 passes to step 706. In step 706, a database schema is defined dynamically to store the parsed data sets. Schemas are created dynamically by connecting to the historical database 56 by standard application program interfaces such as SQL. SQL statements are then used to dynamically create the logical set of tables to define and identify relationships among the data objects to be stored in the historical database 56. If the condition in step 704 is true, the sub-process of FIG. 8 passes to step 708. In step 708, a connection to the historical database 56 is established and the parsed datasets stored in the temporary memory locations are loaded onto the database. Then, the sub-process passes to step 506 in FIG. 6.

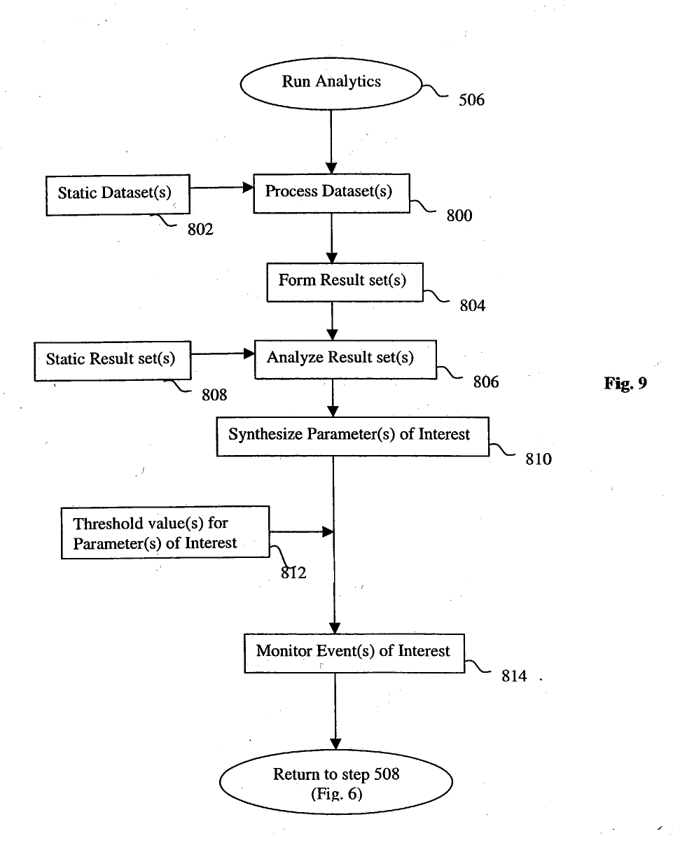

FIG. 9 is a flowchart showing in further detail the “run analytics” step 506 of FIG. 6. After the sub-process of FIG. 8 starts in step 506, the sub-process passes to step 800. In step 800, the parsed datasets are processed. The processing involves computing a measure of risk of investment of the quoted financial assets of the corporation against the risk of investment of a risk free asset. Step 800 can make use of additional static datasets from step 802 to compute the risk measure. The risk measure for the corporation is computed as the average of the differences between the yield of a risk free asset and the corresponding yields of the corporation's quoted assets. The measure of risk is minimized when the average yield difference is small. In step 804, a result set is formed to store the risk measure obtained in the previous step in a temporary memory location. In step 806, the result set obtained in step 804 is analyzed. The analysis involves applying analytics to the risk measure obtained in step 800 to compute the parameters that relate to the event of interest, for example, a corporate default. These parameters include the default frequency and the sharpe ratio. Step 806 can make use of additional static result sets from step 808 to determine the default frequency value. In step 810, the parameters of interest are synthesized. Here, the default frequency parameter is derived from the analytics applied to the risk measure in step 806. The obtained value of the default frequency is an indication of the financial health of the corporation. The default frequency is computed at pre-defined intervals over a time period to determine patterns in default frequency behavior of a corporation. In step 814, the parameters of interest computed in step 810 are monitored. The monitoring involves comparing and classifying the computed parameter against a set of pre-defined threshold values. The parameter value obtained is classified into one of the pre-defined threshold values defined in step 812. The classification of the parameter is indicative of the financial health of the corporate. Then the sub-process passes to step 508 in FIG. 6.

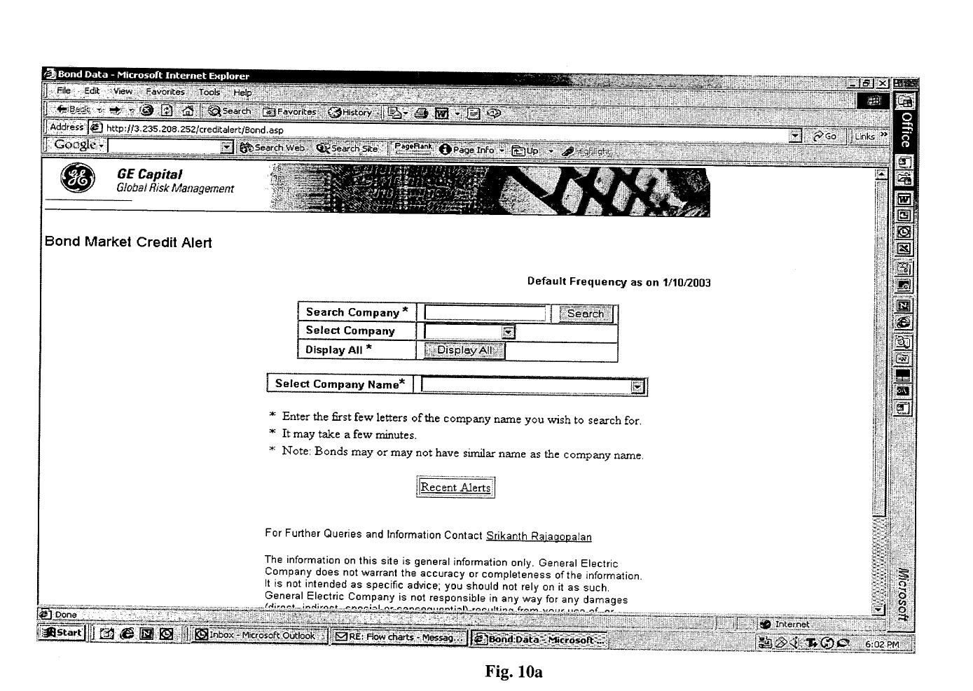

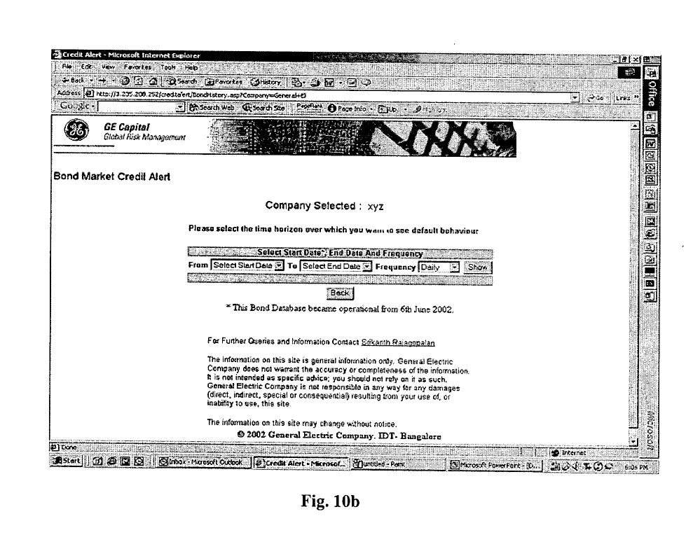

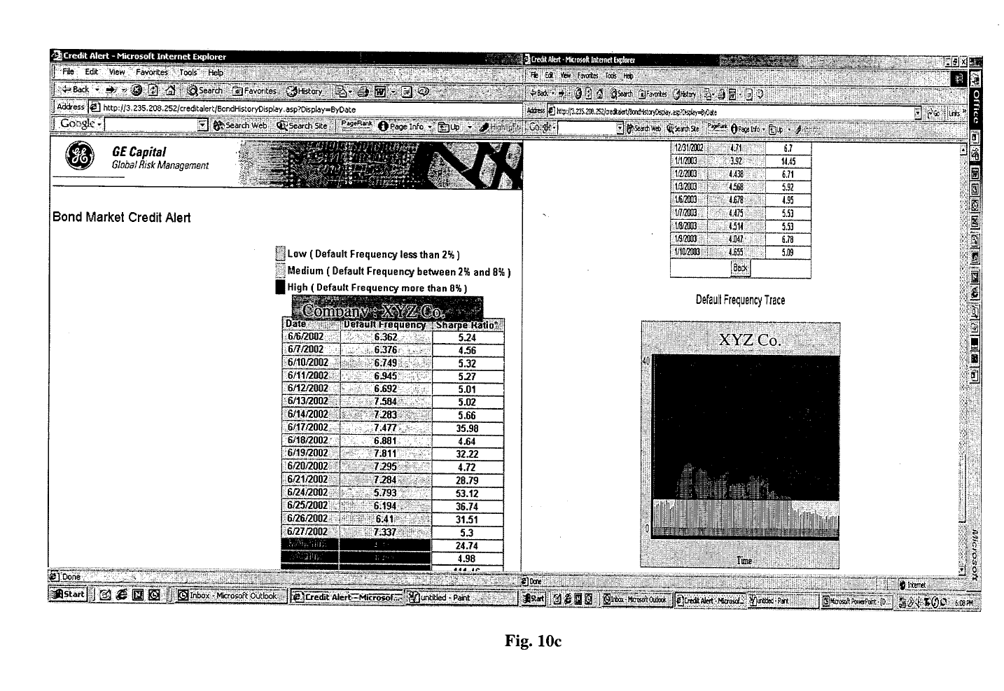

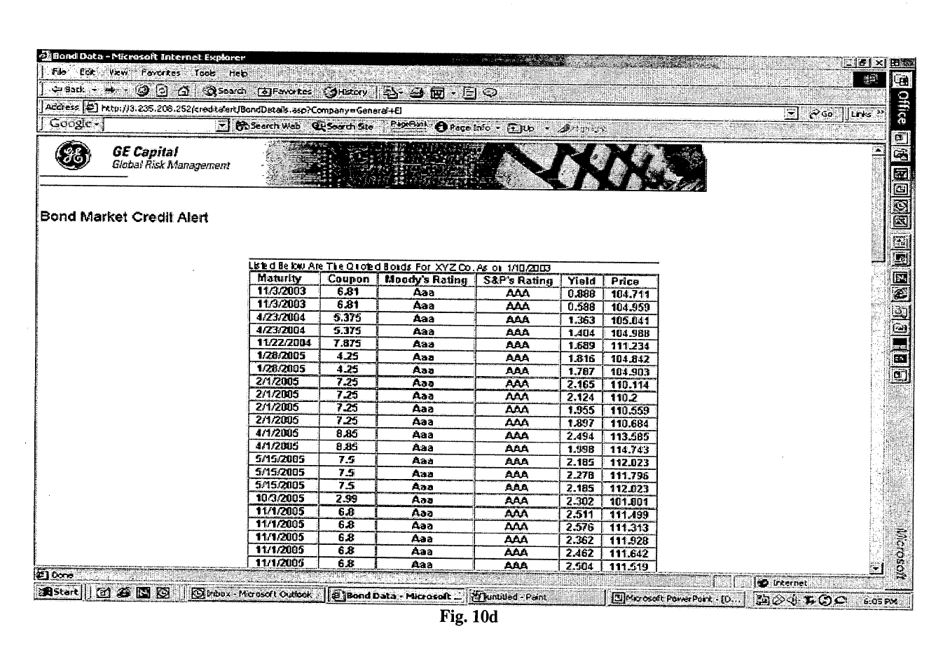

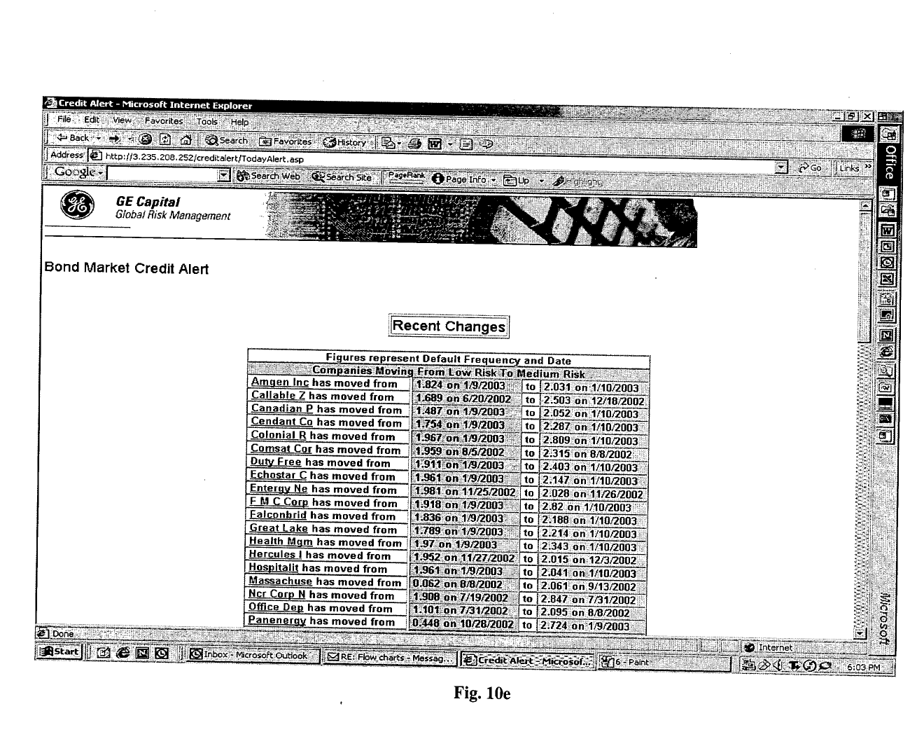

FIGS. 10a-10e show various screen displays that may be presented to a user of the data download and analytics engine 48 as it operates in the manner described with reference to FIGS. 6-9. FIGS. 10a-10e enable a user to view information related to quoted financial assets of a corporation and an event of interest such as the default frequency of a corporation. These screen displays are for illustrative purposes only and are not exhaustive of other types of displays that could be presented to a user for this financial health embodiment or the displays that can be presented in other possible embodiments. Also, the actual look and feel of the displays can be slightly or substantially changed during implementation.

FIG. 10a shows a screen display that enables a user to input a request to search for a corporation of interest. In FIG. 10a, the user can either search a corporation by means of a search criteria or by means of a drop down menu selection. One of ordinary skill in the art will recognize that other fields and additional attribute operators can be used to construct the search request.

FIG. 10b shows a screen display that enables a user to query data related to the financial assets of the searched corporation. In FIG. 10b, a screen comprising of a start date, an end date and a desired interval frequency for viewing transitions to the default frequency of the searched corporation over a time window is displayed to the user. The selections for the start date, end date and interval frequency appear in FIG. 10b as pull-down menus; however, other options for inputting data may be used if desired.

FIG. 10c shows a screen display that may be presented to a user after he or she enters the data present in the screen shot of FIG. 10b. In FIG. 10c, a screen with an updated value of the default frequency computed over a time window as per the desired interval frequency is displayed. Note that the updated value of the default frequency can be traced over the time window both numerically and graphically.

FIG. 10d shows a screen display that may be presented to the user after he or she selects the searched corporation. In FIG. 10d, a screen that enables a user to view the quoted financial assets of the corporation is displayed.

FIG. 10e shows an alert screen that may be presented to the user to view a recent change in the default frequency value for a set of corporations. As shown in FIG. 10e, the alert screen displays a date of change in the default frequency of the corporation and the effect of the change on the financial health of the corporation.

The foregoing flow charts, block diagrams and screen shots of this disclosure show the functionality and operation of the data download and analytics engine subsystem 48. In this regard, each block/component represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Also, one of ordinary skill in the art will recognize that additional blocks may be added. Furthermore, the functions can be implemented in programming languages such as C++ or JAVA; however, other languages can be used such as Perl, Javasript and Visual Basic.

The various embodiments described above comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided in accordance with this invention, a method, system and computer product for real-time monitoring of the financial health of corporations. While the invention has been particularly shown and described in conjunction with a preferred embodiment thereof, it will be appreciated that variations and modifications can be effected by a person of ordinary skill in the art without departing from the scope of the invention.

1. A method for continuously monitoring a plurality of data sources for an event of interest, comprising;
receiving a continuous stream of data from the plurality of data sources;
extracting data that relates to the event of interest from the received data;
storing the extracted data that relates to the event of interest in a historical database;
performing analytics on the stored data that relates to the event of interest; and
monitoring the stored data according to the performed analytics to find data that relates to the event of interest.

2. The method of claim 1, wherein the plurality of data sources comprise data selected from the group of textual data, graphical data and numeric data.

3. The method of claim 1, wherein the receiving comprises automatically searching and downloading data from the plurality of data sources at predetermined time intervals.

4. The method of claim 1, wherein the extracting comprises automatically parsing the received data to extract data that relates to the event of interest.

5. The method of claim 4, wherein the parsing comprises validating and transforming the received data to generate a parsed data set.

6. The method of claim 5, wherein the parsing further comprises loading the parsed data set onto the historical database.

7. The method of claim 1, wherein the storing comprises creating a data storage schema dynamically to store the extracted data in the historical database.

8. The method of claim 1, wherein the performing comprises extracting a desired data set that relates to the event of interest from the historical database.

9. The method of claim 8, wherein the performing further comprises computing a parameter from the desired data set that relates to the event of interest.

10. The method of claim 9, further comprising periodically updating the parameter based on the analytics performed on the continuous stream of data.

11. The method of claim 1, wherein the monitoring comprises comparing the event of interest to a threshold value.

12. An Internet-based method for continuously monitoring a plurality of data sources for information that relates to an event of interest, comprising:
configuring an agent to search the plurality of data sources according to a specific search criteria;
using the agent to download a plurality of web pages containing information related to the plurality of data sources at predetermined time intervals;
parsing the data in the web pages;
storing the parsed data in a data repository;
extracting data from the data repository;
determining parameters of interest from the extracted data, wherein the parameters of interest relate to the event of interest; and
continuously monitoring the determined parameters of interest to find information that relates to the event of interest.

13. The Internet based method of claim 12, wherein the data sources comprise data selected from the group of textual data, graphical data and numeric data.

14. The Internet based method of claim 12, wherein the configuring comprises using a browser object with a search string embedded in it.

15. The Internet based method of claim 12, wherein the parsing comprises extracting data that relates to the event of interest from the plurality of web pages.

16. The Internet based method of claim 15, wherein the parsing further comprises validating and transforming the extracted data to generate the parsed data.

17. The Internet based method of claim 12, wherein the storing comprises loading the parsed data onto the data repository.

18. The Internet based method of claim 17, wherein the storing further comprises creating a data storage schema dynamically to load the parsed data set in the data repository.

19. The Internet based method of claim 12, wherein the extracting comprises performing analytics on the stored data to extract information relevant to the event of interest.

20. The Internet based method of claim 12, wherein the parameters of interest comprise corporate defaults, financial distress, corporate leasing decisions and weather forecasts.

21. A system for continuously monitoring a plurality of data sources for an event of interest, comprising;
an agent configured to automatically search and download data from the plurality of data sources at pre-determined time intervals;
a data extraction component configured to extract data that relates to the event of interest from the data downloaded by the agent;
a database configured to store the extracted data that relates to the event of interest; and
an analytics engine configured to perform analytics on the stored data.

22. The system of claim 21, wherein the plurality of data sources comprise data selected from the group of textual data, graphical data and numeric data.

23. The system of claim 21, wherein the agent comprises a browser object with a search string embedded in it.

24. The system of claim 21, wherein the data extraction component is configured to automatically parse the downloaded data to extract information that relates to the event of interest.

25. The system of claim 24, wherein the data extraction component is further configured to validate and transform the data to generate a parsed data set.

26. The system of claim 25, wherein the data extraction component is configured to load the parsed data set onto the database.

27. The system of claim 21, wherein the database is configured to create a data storage schema dynamically to store the extracted data in the historical database.

28. The system of claim 21, wherein the analytics engine is configured to extract a desired data set that relates to the event of interest from the database.

29. The system of claim 28, wherein the analytics engine is configured to compute a parameter from the desired data set, wherein, the parameter relates to the event of interest.

30. The system of claim 21, wherein the analytics engine is configured to continuously monitor the stored data to find information that relates to the event of interest.

31. A computer-readable medium storing computer instructions for instructing a computer system to continuously monitor a plurality of data sources for an event of interest, the computer instructions comprising;
receiving a continuous stream of data from the plurality of data sources;
extracting data that relates to the event of interest from the received data storing the extracted data that relates to the event of interest in a historical database;
performing analytics on the stored data that relates to the event of interest; and
monitoring the stored data according to the performed analytics to find data that relates to the event of interest.

32. The computer-readable medium of claim 31, wherein the plurality of data sources comprise data selected from the group of textual data, graphical data and numeric data.

33. The computer-readable medium of claim 31, wherein the receiving comprises receiving instructions for automatically searching and downloading data from the plurality of data sources at predetermined time intervals.

34. The computer-readable medium of claim 31, wherein the extracting comprises processing instructions for automatically parsing the received data to extract data that relates to the event of interest.

35. The computer-readable medium of claim 34, wherein the parsing further comprises instructions for validating and transforming the received data to generate a parsed data set.

36. The computer-readable medium of claim 35, wherein the parsing further comprises instructions for loading the parsed data set onto the historical database.

37. The computer-readable medium of claim 31, wherein the storing comprises instructions for creating a data storage schema dynamically to store the extracted data in the historical database.

38. The computer-readable medium of claim 31, wherein the performing comprises instructions for extracting a desired data set that relates to the event of interest from the historical database.

39. The computer-readable medium of claim 38, wherein the performing further comprises instructions for computing a parameter from the desired data set that relates to the event of interest.

40. The computer-readable medium of claim 39, further comprising instructions for periodically updating the parameter based on the analytics performed on the continuous stream of data.

41. The computer-readable medium of claim 31, wherein the monitoring comprises instructions for comparing the event of interest to a threshold value.

42. A computer-readable medium storing computer instructions for instructing a computer system to continuously monitor a plurality of data sources from the Internet for information that relates to an event of interest, comprising:
configuring an agent to search the plurality of data sources according to a specific search criteria;
using the agent to download a plurality of web pages containing information related to the plurality of data sources at predetermined time intervals;
parsing the data in the web pages;
storing the parsed data in a data repository;
extracting data from the data repository;
determining parameters of interest from the extracted data, wherein the parameters of interest relate to the event of interest; and
continuously monitoring the determined parameters of interest to find information that relates to the event of interest.

43. The computer-readable medium of claim 42, wherein the data sources comprise data selected from the group of textual data, graphical data and numeric data.

44. The computer-readable medium of claim 42, wherein the configuring comprises instructions for using a browser object with a search string embedded in it.

45. The computer-readable medium of claim 42, wherein the parsing comprises instructions for extracting data that relates to the event of interest from the plurality of web pages.

46. The computer-readable medium of claim 45, wherein the parsing further comprises instructions for validating and transforming the extracted data to generate the parsed data.

47. The computer-readable medium of claim 42, wherein the storing comprises instructions for loading the parsed data onto the data repository.

48. The computer-readable medium of claim 47, wherein the storing further comprises instructions for creating a data storage schema dynamically to load the parsed data set in the data repository.

49. The computer-readable medium of claim 42, wherein the extracting comprises instructions for performing analytics on the stored data to extract information relevant to the event of interest.

50. The computer-readable medium of claim 42, wherein the parameters of interest comprise corporate defaults, financial distress, corporate leasing decisions and weather forecasts.

51. A method in a computer system for displaying a plurality of pages to enable a user to view information related to quoted financial assets of an entity to determine the financial health of the entity, comprising:
displaying an input screen for permitting the user to input a request to search for the entity;
displaying a query screen for permitting a user to query for data related to the financial assets for the searched entity; and
displaying an alert screen for permitting the user to view a recent change to the financial health of at least one entity.

52. The method of claim 51, wherein the financial health is computed based on online analysis of the quoted financial assets pertaining to the entity.

53. The method of claim 52, wherein the financial health further comprises detection of default frequency behavior of the entity.

54. The method of claim 51, wherein the input screen for permitting the user to input a request to search for the entity comprises querying for the entity by means of a user input search string.

55. The method of claim 51, wherein the input screen for permitting the user to input a request to search for the entity further comprises searching for the entity by means of a drop down menu selection.

56. The method of claim 51, wherein the query screen for permitting a user to query data related to the financial assets for the searched entity comprises displaying a screen with a start date, an end date and a desired interval frequency for viewing transitions to the financial health of the searched entity over a time window.

57. The method of claim 56, wherein viewing the transitions in the financial health of the searched entity over the time window comprises displaying a screen with an updated value of the financial health computed over the time window as per the desired interval frequency; and wherein the updated value of the computed financial health is traced over the time window numerically and graphically.

58. The method of claim 57, wherein the financial health reflects a risk of default of the entity over the time window.

59. The method of claim 51, wherein the query screen for permitting a user to query data related to the financial assets further comprises displaying a screen for viewing the quoted financial assets pertaining to the entity.

60. The method of claim 51, wherein the alert screen for permitting the user to view a recent change in the financial health for at least one entity comprises displaying a screen for viewing a date of change in the financial health of the entity and the effect of the recent change on the financial health of the entity.

61. The method of claim 60, wherein the recent change in the financial health of the entity represents the current financial health of the entity on the date of change.

62. A system for continuously monitoring a plurality of data sources for an event of interest, comprising:
a processing unit configured to download, extract and analyze a continuous stream of data from the plurality of data sources, the processing unit comprising:
a data fetch entity configured to automatically search and download the continuous stream of data from the plurality of data sources;
a data extraction entity configured to extract data that relates to the event of interest from the continuous stream of data; and
an analytics engine configured to compute and monitor a parameter of interest related to the event of interest from the extracted data;
a memory unit configured to store a plurality of data used by the processing unit; and
a user interface configured to interface the processing unit with a user.

63. The system of claim 62, wherein the data fetch entity of the processing unit comprises a data seeking portion configured to connect to and download the continuous stream of data from the plurality of data sources.

64. The system of claim 62, wherein the data extraction entity of the processing unit comprises:
a rules processing portion configured to process rules to extract data from the continuous stream of data that relates to the event of interest;
a data parsing portion configured to validate and transform the extracted data to generate a parsed data set; and
a data loading portion configured to load the parsed data set onto a data repository.

65. The system of claim 62, wherein the analytics engine of the processing unit comprises:
a rules generation portion configured to classify the parameter into pre-defined threshold ranges;
a data processing portion configured to compute the parameter that relates to the event of interest from the extracted data; and
a data loading portion configured to load the computed parameter onto a data repository.

66. The system of claim 62, wherein the memory unit comprises:
a data seeker memory portion configured to store the continuous stream of data from the plurality of data sources;
a rules memory portion configured to store rules for data extraction and threshold values for the parameter;
a parser memory portion configured to store the extracted data that relates to the event of interest; and
a data process memory portion configured to store information related to the computed parameter.

67. The system of claim 62, wherein the user interface comprises displaying a plurality of pages to enable a user to view information related to the event of interest.
